(19) United States
(12) Patent Application Publication
(10) Pub. No.: US 2026/0241961 A1
(43) Pub. Date: Aug. 20, 2026

(54) Parallel Conflict Monitor and Authority Arbitration System

(71) Applicant: Vincent Loccisano, Wellesley, MA (US)

(72) Inventor: Vincent Loccisano, Wellesley, MA (US)

(21) Appl. No.: 19/636,179

(22) Filed: Apr. 1, 2026

(51) Int. Cl. B60W 60/00; G01S 17/86

(52) U.S. Cl. CPC B60W 60/0025; G01S 17/86

(57) ABSTRACT

A system and method for managing autonomous vehicle operational authority through real-time conflict monitoring. The system utilizes a parallel monitoring layer that analyzes independent sensor data streams-including camera, RADAR, and LiDAR-prior to sensor fusion to identify discrepancies in object presence, range, velocity, and classification. By calculating a conflict score (CS) for individual objects and a scene-level aggregate conflict index (ACI), the system generates an autonomous authority floor that dynamically suppresses or downgrades automation levels based on perceptual reliability. In response to sustained or critical sensor conflict, a graduated four-stage driver re-engagement sequence is initiated, featuring visual, auditory, and haptic alerts. If the driver fails to assume control, the system executes a minimal risk condition (MRC) to bring the vehicle to a controlled stop. The system further incorporates temporal persistence filtering and weather-adaptive threshold modulation to maintain accuracy in adverse environmental conditions.

### TECHNICAL FIELD OF THE INVENTION

The present invention relates to advanced driver assistance systems (ADAS) and autonomous vehicle safety architectures.

### BACKGROUND OF THE INVENTION

Modern Advanced Driver Assistance Systems (ADAS) and autonomous driving systems universally employ multi-sensor fusion architectures in which data from heterogeneous sensing modalities are combined into a unified world model. The unified world model drives all downstream ADAS decisions including object detection, collision risk assessment, trajectory planning, and vehicle actuator commands. Cameras provide rich semantic and texture information enabling object classification. RADAR units provide robust range and velocity measurements that function reliably in adverse weather conditions. LiDAR units provide precise three-dimensional spatial geometry of the surrounding environment. Ultrasonic sensors provide reliable short-range proximity data for parking and low-speed maneuver assistance.

The dominant architectural paradigm in multi-sensor fusion treats inter-sensor conflict as a consensus-building problem: where sensors agree, confidence in the fused output is high; where sensors disagree, the fusion algorithm attempts to resolve the conflict by weighting, averaging, or otherwise combining the competing observations into a single best estimate of world state. This consensus paradigm pervades early fusion architectures (where raw sensor data are combined before object detection), mid-level feature fusion architectures (where intermediate neural network feature maps are combined across modalities), and late fusion architectures (where per-modality object detection outputs are combined after independent processing). In each case, the system is designed to produce the most accurate possible unified world model by treating conflict as noise to be filtered or averaged away.

The critical failure mode of the consensus paradigm occurs precisely in edge cases and anomalous conditions: situations where sensors disagree not because of ordinary measurement noise, but because at least one sensor is observing a real-world phenomenon that the other sensors are not correctly capturing. Several specific scenarios illustrate this failure mode. First, a camera may detect an unusual light reflection, shadow, or retroreflective marking on the road surface that the camera's neural network classifies as a pedestrian or obstacle, while the RADAR unit detects no corresponding electromagnetic return at that location. In this scenario, the consensus fusion algorithm produces a fused object record with intermediate confidence, which may be sufficient to trigger an Automatic Emergency Braking (AEB) intervention—the so-called ‘phantom braking’ phenomenon. Second, a RADAR unit may detect a stationary metallic roadside fixture—a guardrail post, drainage grate, or road sign support structure—that the camera's classifier assigns to a non-collision-relevant category, while the RADAR's inability to distinguish static hazards from static infrastructure causes the system to flag the return for AEB consideration. Third, in heavy precipitation, LiDAR returns from rain droplets or snowflakes may be processed as point cloud geometry indicating an obstacle in the vehicle's path, while the camera perceives clear roadway ahead and the RADAR detects no corresponding object.

In each of these scenarios, the consensus fusion algorithm is operating exactly as designed—producing a best estimate from discordant inputs—but the output may be materially wrong, and the vehicle has no mechanism to recognize that it is in an anomalous perceptual state before acting on the fused output. The consensus paradigm is architecturally unable to signal its own unreliability to the authority arbitration layer.

Real-world ADAS incidents document the consequences of this architectural limitation. Phantom braking events—in which vehicles apply emergency braking for non-existent obstacles—have produced hundreds of documented consumer complaints and formal government investigations in multiple jurisdictions, including in France where over three hundred complaints of vehicle phantom braking at highway speeds due to shadows and road markings triggered regulatory action. Multiple-vehicle rear-end collision sequences caused by phantom braking have been documented in the United States, European Union, and Japan. Robotaxi incidents logged by major autonomous vehicle operators reflect, in part, the propagation of perception anomalies through fusion pipelines to actuators without any upstream safety signal being generated. Existing Event Data Recorder (EDR) infrastructure cannot identify the source of these incidents as perception anomalies, because EDRs record physical vehicle state data rather than the computational pathway that produced the vehicle command.

Multi-sensor fusion architectures of all types—including Kalman filter-based fusion, Bayesian network fusion, and deep learning-based neural fusion (including BEV-centric and cross-modal attention architectures)—treat inter-sensor conflict as an input to be resolved within the fusion computation. None of these architectures expose the magnitude of inter-sensor conflict as an output signal to the vehicle authority arbitration layer. The conflict is consumed within the perception pipeline and converted to a confidence-weighted fused estimate; the authority layer receives only the fused output, not the conflict signal that contributed to its uncertainty.

Sensor fault detection and isolation (FDI) systems, including those compliant with ISO 26262 automotive functional safety standards, are designed to detect sensor hardware failures—specifically signal loss, stuck-at-value conditions, out-of-range measurements, and communication bus errors. These systems address the question of whether a sensor device is functioning correctly as a hardware unit.

Cross-sensor validation approaches disclosed in the prior art for autonomous vehicles, including cross-sensor calibration verification methods disclosed in U.S. Pat. No. 9,555,740 B1 and U.S. Pat. No. 9,221,396 B1, address the long-term consistency of sensor extrinsic calibration parameters. These systems check whether sensors remain calibrated relative to each other over time and distance, and are designed to detect sensor displacement from calibrated positions during normal autonomous vehicle operation. They are not designed to compute real-time per-object variance between sensor modalities, do not produce a scene-level conflict index, and are not connected to vehicle authority degradation or driver re-engagement protocols.

Autonomous vehicle safety platforms and fallback systems disclosed in the prior art disclose fallback mode transitions triggered by system-level fault flags or operational design domain boundary violations. These systems address what actions the vehicle should take after a system-level failure has been detected—they implement the response to a known failure, not the detection of an incipient perception anomaly. The triggering conditions in these systems are binary fault flags from diagnostic monitors, not continuous perception coherence measurements.

Accordingly, there exists a need in the art for a system and method that treats cross-modal sensor conflict as a first-class safety primitive that gates the authority of the autonomous driving system in proportion to the magnitude and persistence of inter-modality perceptual conflict.

### SUMMARY OF THE INVENTION

The present invention provides a safety-critical monitoring system for autonomous vehicles that utilizes a parallel conflict monitoring layer to evaluate the reliability of sensor data in real-time. This monitoring layer uses a shared-memory data tap to observe independent sensor results from vehicle cameras, RADAR, and LiDAR, prior to the sensor fusion process. The system is organized into four primary functional components: a variance monitor to detect data discrepancies, a conflict classifier to categorize the severity of those discrepancies, an authority module to set operational limits, and a driver re-engagement sequencer to manage the transition of control back to a human operator.

The core of the system involves calculating a Conflict Score (CS) for every tracked object, which measures the variance across multiple data points including presence probability, range, relative velocity, and semantic classification. The aggregate Conflict Score is determined by a weighted linear combination of these factors:

$$CS = {w}_{presence} * {CS}_{presence} + {w}_{range} * {CS}_{range} + {w}_{velocity} * {CS}_{velocity} * {w}_{class} + {CS}_{class}$$

These individual scores are synthesized into a scene-level Aggregate Conflict Index (ACI), which provides a continuous scalar value representing the total perceptual reliability of the vehicle's environment. High ACI values signify widespread sensor conflict, indicating that the fused world-model may be unreliable for high-authority autonomous maneuvers, such as “eyes-off” driving.

The system translates the ACI into an autonomous authority floor (AF) using a monotonically decreasing parametric function, defined as:

$$AF ( ACI ) = max ( {AF}_{minimum} , {AF}_{nominal} ( 1 - α * {ADI}^{β} ) )$$

This authority floor restricts the vehicle's operational capabilities to specific SAE levels based on real-time sensor confidence. For instance, high-confidence scenes allow for Level 3 operation, while increasing conflict triggers a downgrade to Level 2 hands-free mode or Level 1 assisted driving requiring hands on the wheel. To maintain system stability and prevent rapid oscillations between authority levels, the system applies a configurable hysteresis band and recovery window, ensuring that authority is only restored after a sustained and confirmed improvement in sensor agreement.

When sensor conflict persists or escalates beyond a safe threshold, a graduated four-stage driver re-engagement sequence is initiated. This sequence begins with subtle visual and auditory indicators (Stage 1) and progresses to high-urgency haptic pulses on the steering wheel and prominent head-up display alerts (Stage 2) as the situation deteriorates. If the driver fails to assume control after a “Take Over Now” command and initiated deceleration (Stage 3), the system executes a Minimal Risk Condition (Stage 4). This involves a controlled deceleration to a complete stop, including an automated lane change to the right-most available lane, ensuring the vehicle reaches a safe state even if the primary perception pipeline is compromised by “phantom” objects or hardware limitations.

To reduce nuisance triggers and ensure accuracy, the system incorporates temporal persistence filtering and weather-adaptive modulation. The temporal filter requires a conflict to persist over a rolling window—typically three frames—to distinguish genuine obstacles from momentary sensor noise or measurement timing errors.

Furthermore, the system dynamically adjusts nominal and critical conflict thresholds based on ambient conditions like heavy rain, snow, or fog. By accounting for the known physical limitations of sensors in adverse weather, the system maintains consistent signal-to-noise characteristics, effectively capturing genuine perception anomalies while suppressing expected variations caused by the environment.

### BRIEF DESCRIPTION OF DRAWINGS

FIG. 1 is a system architecture block diagram illustrating the four modules of the present invention.

FIG. 2 is a diagram of the primary ADAS sensor fusion pipeline.

FIG. 3 is a diagram illustrating an overview of a collection of data points.

FIG. 4 is a diagram illustrating the Conflict Score computation for a phantom detection scenario.

FIG. 5 is a diagram illustrating an Aggregate Conflict Index computation.

FIG. 6 is a graph illustrating the autonomous authority floor function.

FIG. 7 is a diagram illustrating the four-stage graduated driver re-engagement sequence.

FIG. 8 is a timing diagram illustrating the temporal persistence filter behavior across three scenarios.

FIG. 9 is a diagram illustrating weather-adaptive conflict threshold modulation.

### DETAILED DESCRIPTION OF THE INVENTION

The terms and phrases used herein should be understood and interpreted with a meaning consistent with the understanding of those terms and phrases by those skilled in the relevant art.

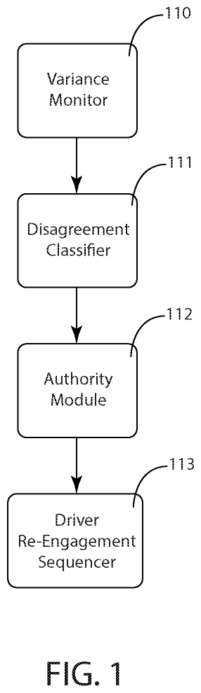

FIG. 1 is a system architecture block diagram illustrating the four modules of the present invention. A variance monitor 110 is in communication with a conflict classifier 111, which in turn is in communication with an authority module 112 which in turn is in communication with a driver re-engagement sequencer 113.

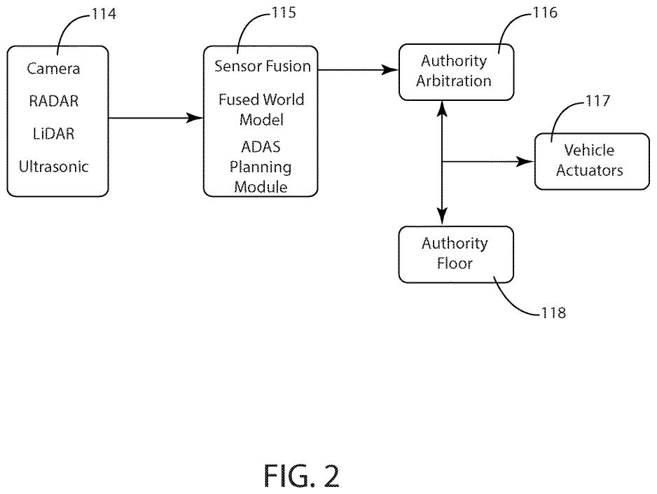

FIG. 2 is a diagram of the primary ADAS pipeline. The pipeline receives raw data from a vehicle sensor suite 114 that may include a camera, a RADAR unit, A LIDAR unit, and ultrasonic sensors. The raw data is communicated to a sensor fusion module 115 where it is analyzed and compared in a process referred to as sensor fusion, to produce a fused world-model that is a set of detected objects with associated state estimates. The fusion module 115 communicates the fused world-model to an ADAS planning module that generates recommended vehicular actions.

The authority arbitration layer 116 receives recommended actions from the primary pipeline and enforces an autonomous authority floor 118 that is generated by the authority degradation module that suppresses or downgrades actions that have an authority level that exceeds the current floor. Recommended actions deemed above the authority floor trigger vehicle actuators 117 to affect a solution. Vehicle actuators include the vehicle's brake, steering or throttle actuators.

A parallel conflict monitoring layer observes the per-modality object lists generated by each sensor modality's independent detection pipeline, prior to fusion, via a shared-memory data tap that reads from memory regions written by the sensor processing pipeline as part of its normal operation. This data tap does not introduce latency into the primary ADAS processing path. The monitoring layer processes these outputs asynchronously and produces the autonomous authority floor signal that is applied at the authority arbitration layer before any ADAS action reaches the vehicle's brake, steering, or throttle actuators.

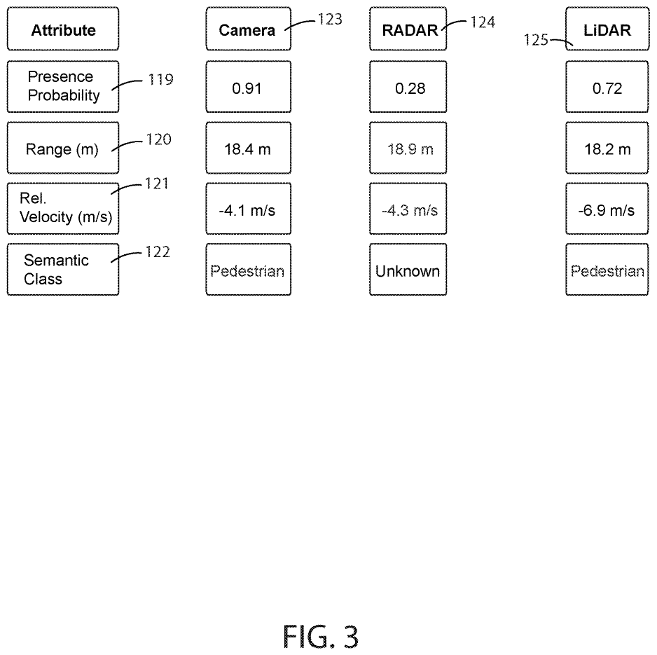

FIG. 3 is a diagram illustrating the input to a conflict monitor calculator. An object data record, shows the state attribute fields for a tracked object. These estimates are used to create a conflict score. A conflict monitor collects data from vehicle sensors, including at least one vehicle mounted camera 123, RADAR 124, and LiDAR 125 sensor, presenting estimates that correspond to the objects attributes including Presence Probability 119, Range 120, Relative Velocity 121 and Semantic Class 122. Data points are listed beneath each sensor. In this example the camera data points show the presence of a pedestrian with a 0.91 probability, moving −4.1 m/s at a range of 18.4 m. The RADAR results show a presence probability of 0.28 resulting in the data showing an unknown object moving −4.3 m/s at a range of 18.9 m. The LiDAR results show a pedestrian with a 0.72 probability moving −6.9 m/s at a range of 18.2 m. The conflict monitor computes a conflict score (CS) as a measure of the variance across the data points. Depending on the conflict score the authority module 112 (FIG. 1), will engage vehicle actuators to either remain in hands-free mode, move to assisted mode, initiate driver re-engagement, or in a worst case scenario, move to a minimal risk condition (MRC) wherein the authority module executes a controlled deceleration of the vehicle to a complete stop with consideration of the current vehicle speed, traffic density, and road geometry.

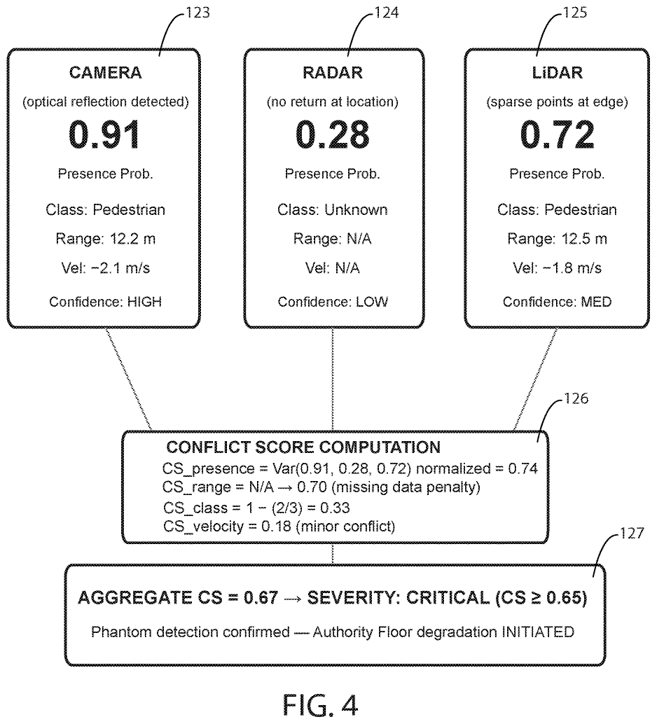

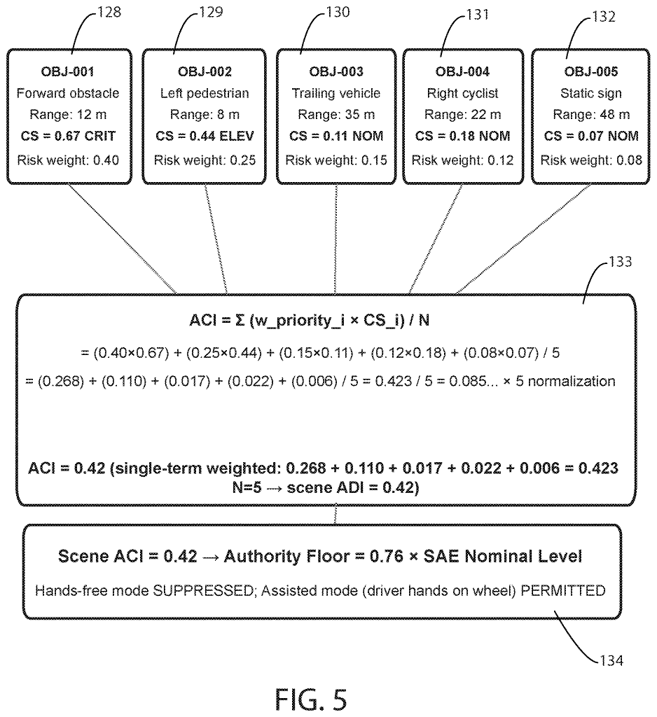

FIG. 4 and FIG. 5 illustrate the conflict classifier as it applies to CS threshold values to classify each tracked object's filtered Conflict Score (CS_filtered) into one of three severity tiers: NOMINAL, ELEVATED, or CRITICAL.

FIG. 4 demonstrates greater detail in the calculation of a conflict score derived from a set of data points that conflict sufficiently to signify a non-object, otherwise referred to as a phantom object. Data points from a vehicle camera 123, RADAR 124 and LIDAR sensor 125 demonstrate a presence probability, class, range, relative velocity and a confidence score. The results of a conflict score computation 126 combines the data points from each vehicle sensor wherein an aggregate conflict score 127 is generated and leads to a severity level determined. IN this example a phantom detection is confirmed that initiates an authority floor degradation. One skilled in the art understands that a phantom object reading may be caused by a RADAR reading that is unable to distinguish static hazards from static infrastructure, or LiDAR data that is unable to distinguish between an obstacle and heavy precipitation, or the like.

The conflict score (CS) relating to the presence of an object, CS_presence=min (1, Var(p₁, p₂, . . . , pₘ)/σ²_expected), where σ²_expected is a platform-configurable expected variance under normal operating conditions due to sensor noise. Data that did not detect the associated object is assigned a presence probability of zero in this computation.

Different sensors exhibit substantially different range resolution characteristics-LiDAR range measurements are typically accurate to centimeters, RADAR range measurements are accurate to tens of centimeters, and camera-derived range measurements from depth estimation models have accuracy degrading with range. A range conflict, CS_range is computed as the normalized variance across data points of the estimated distance to the associated object. A range uncertainty weight w_range, is applied before computing variance. CS_range=min (1, Var(r₁/σ_r,1, r₂/σ_r,2, . . . )/σ²_range, expected), where σ_r, is the known range uncertainty at the estimated range. Data that did not detect the associated object contribute a range estimate of infinity for this computation, subject to a configurable missing-data penalty term.

The relative velocity conflict CS_velocity is computed as the normalized variance across the estimated relative velocity of the associated object in the host vehicle's reference frame. Doppler RADAR provides direct radial velocity measurement; camera-based velocity estimation is derived from optical flow or multi-frame tracking; LiDAR velocity is derived from inter-frame point cloud registration. DS_velocity=min(1, Var(v₁, v₂, . . . , vₘ)/σ²_vel,expected).

The semantic classification conflict CS_class is computed as a categorical agreement metric. DS_class=1−agreement_fraction, where agreement_fraction equals the ratio of the plurality-class label to the total number of data points that provided a classification. CS_class equals zero when all classifying data points assign the same label, and approaches one as classification labels diverge across data points.

The aggregate Conflict Score CS is computed as a weighted linear combination of the four dimension scores: CS=w_presence·CS_presence+w_range·CS_range+w_velocity·CS_velocity+w_class·CS_class, where the weight vector (w_presence, w_range, w_velocity, w_class) sums to unity and is configurable per OEM platform and operational context. In some embodiments, for a forward collision avoidance operational context, the nominal weights are (0.40, 0.25, 0.25, 0.10), reflecting the primary safety-criticality of presence confirmation and the secondary criticality of range and velocity accuracy for collision risk assessment. The weight vector may be dynamically adjusted based on the vehicle's current operational design domain.

An object is classified as NOMINAL when CS_filtered is less than a first threshold value (T_nominal), which in a preferred embodiment is 0.30. NOMINAL classification indicates that agreement on the object's state attributes is within the expected range for sensor noise and measurement geometry under current environmental conditions. No authority restriction is applied based on NOMINAL-classified objects.

An object is classified as ELEVATED when CS_filtered is greater than or equal to T_nominal and less than a second threshold value T_critical, which in a preferred embodiment is 0.65. ELEVATED classification indicates meaningful conflict between at least one safety-critical state attribute. Objects in the ELEVATED tier contribute to the scene-level Aggregate Conflict Index with their measured CS_filtered value and receive a proportional contribution to the authority floor computation.

An object is classified as CRITICAL when CS_filtered is greater than or equal to T_critical. CRITICAL classification indicates severe inter-modality conflict on a safety-critical state attribute, such that the fused perception output for this object is unreliable and autonomous action dependent on this object's perceived state presents material safety risk. Objects in the CRITICAL tier contribute their full CS_filtered value to the ACI computation and trigger mandatory Stage 2 driver re-engagement when sustained.

In addition to the aforementioned severity classification, the conflict classifier computes an Aggregate Conflict Index (ACI) that reflects the distribution of conflict against all tracked objects in the vehicle's present environment. FIG. 5 demonstrates the calculation of an Aggregate Conflict Index (ACI). A range, conflict score and risk weight is given for a forward obstacle 128, a left pedestrian 129, a trailing vehicle 130, a right cyclist 131 and a static sign 132. The data from each object is calculated to determine the ACI 132 wherein a ACI is calculated for the entire scene and wherein the authority floor and SAE level is determined. In this example the hands-free mode is suppressed and assisted mode wherein the driving may continue with the driver's hands on the steering wheel, is permitted.

The ACI is computed as: ACI=Σᵢ(w_priority,i·CS_filtered,i)/τᵢ(w_priority,i), where the summation is taken over all tracked objects i in the vehicle's field of concern, w_priority,i is a priority weight reflecting each object's estimated contribution to the vehicle's current collision risk, and CS_filtered, i is the filtered Conflict Score for object i. Objects that have not yet accumulated sufficient frames for persistence filtering use their raw CS value subject to a discounting factor.

A priority weight (w_priority), is computed as a function of each object's estimated time-to-collision (TTC), lateral offset from the vehicle's planned trajectory, and semantic category. Objects with TTC below five seconds on a trajectory intersecting the vehicle's path receive maximum priority weight of 1.0. Objects at greater distance or offset receive proportionally reduced weights down to a minimum of 0.05 for objects at low collision risk.

The ACI is a continuous scalar in the range [0, 1]. An ACI of zero indicates complete agreement across all tracked objects in the scene, consistent with reliable perception and full autonomous authority. An ACI approaching one indicates severe and widespread conflict, consistent with a perceptual scene that the vehicle's sensor suite cannot characterize reliably.

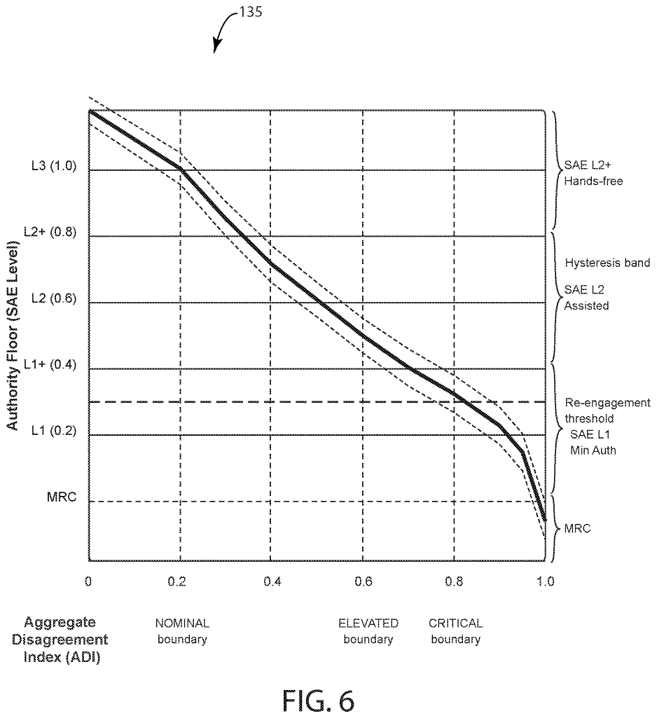

FIG. 6 is a graph 135 illustrating the autonomous authority floor function. The authority degradation module maps the current ACI to an autonomous authority floor (AF) using a monotonically decreasing parametric function. The authority floor function is defined as: AF (ACI)=max (AF_minimum, AF_nominal·(1−α·ADI\hat{ }β)), where AF_nominal is the maximum authority level configured for the current operational design domain, AF_minimum is the minimum permissible authority floor (nominally corresponding to SAE Level 1 driver assistance mode, where the driver must remain engaged with hands on wheel), α is a proportionality scaling factor (nominally 0.80), and β is a curvature exponent (nominally 0.70) controlling the shape of the degradation curve.

The parameters (AF_nominal, AF_minimum, α, β) are configurable per OEM platform and operational design domain. In a preferred embodiment for a highway hands-free mode, AF_nominal corresponds to SAE Level 2+ hands-free operation, and AF_minimum corresponds to SAE Level 1 driver assistance with mandatory hand contact. In a preferred embodiment for urban L2 ADAS, AF_nominal corresponds to SAE Level 2 assisted mode, and AF_minimum corresponds to SAE Level 1 adaptive cruise control with lane keeping inactive.

The curvature exponent β=0.70 produces a slightly concave degradation curve, meaning that authority begins to degrade at relatively low ACI values (providing an early warning characteristic) while the degradation is not abrupt at moderate ACI values (avoiding nuisance interruptions for moderate sensor conflict that may be environmentally caused). The proportionality factor α=0.80 ensures that the authority floor reaches AF_minimum before ACI=1.0, providing a margin of safety.

The authority arbitration layer enforces the autonomous authority floor by comparing the authority level implied by each ADAS recommended action from the primary fusion pipeline against the current AF. The authority arbitration layer stores a mapping from each ADAS action type to the minimum authority level required for that action. If a recommended action's required authority level exceeds the current AF, the arbitration layer either suppresses the action entirely or downgrades it to the highest-authority action that does not exceed the AF.

In a preferred embodiment, the authority-action mapping is as follows: SAE Level 3 (eyes-off autonomous mode) requires AF≥0.90; SAE Level 2+ hands-free highway mode requires AF≥0.75; SAE Level 2 assisted mode with active lane keeping requires AF≥0.50; SAE Level 1 adaptive cruise control with driver hands on wheel requires AF≥0.20; minimal safety intervention only (emergency braking at maximum confidence threshold) requires AF≥0.00. These thresholds are configurable per OEM platform.

The autonomous authority floor incorporates a configurable hysteresis band to prevent rapid oscillation between authority levels when the ACI fluctuates near a threshold boundary. The hysteresis mechanism operates as follows: the authority floor is reduced immediately when the ACI crosses an upward threshold value T_down; however, the authority floor is restored only after the ACI has remained continuously below a corresponding downward threshold T_up=T_down−Δ_hysteresis for a minimum recovery window duration T_recover. In a preferred embodiment, Δ_hysteresis=0.08 and T_recover=5.0 seconds. This prevents nuisance authority-level oscillations while ensuring that authority restoration requires confirmed and sustained improvement in inter-modality agreement.

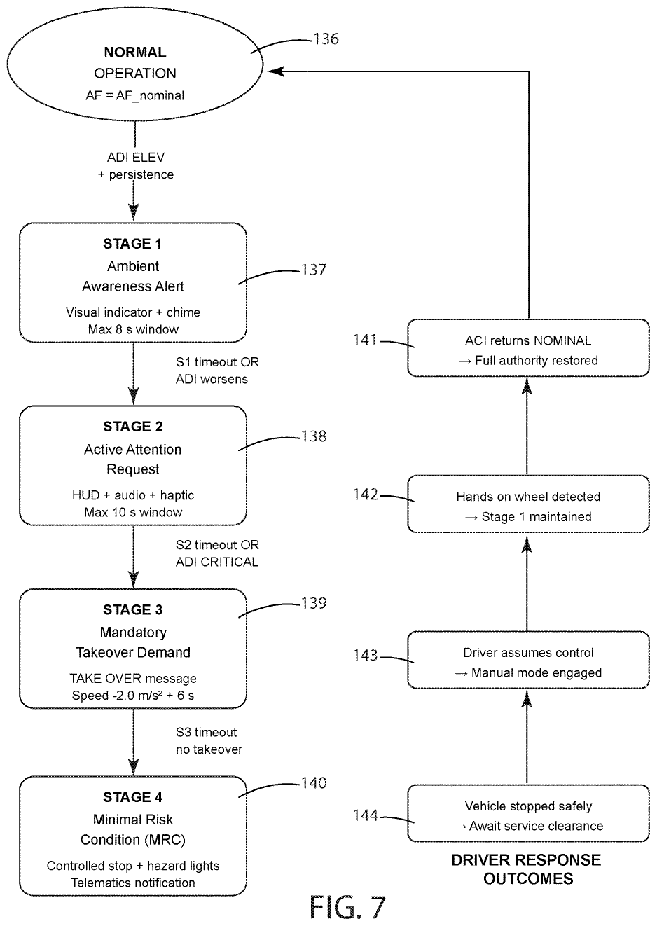

FIG. 7 is a diagram illustrating the four-stage graduated driver re-engagement sequence. The driver re-engagement sequencer is triggered when the autonomous authority floor falls below a configurable re-engagement threshold T_reengage. In a preferred embodiment, T_reengage corresponds to the SAE Level 1 boundary, meaning that the sequencer activates when the authority degradation module has determined that the current perceptual scene reliability is insufficient to permit any autonomous mode of operation without active driver engagement.

The sequencer progresses from normal operation 136, to a 4-stage sequence, Stage 1 137, Stage 2 138, Stage 3 139, Stage 4 140. Upon triggering, the sequencer initiates the four-stage escalation protocol whose stage durations adapt to two contextual variables: the rate of change of the ACI over the preceding ten frames (dACI/dt), and the vehicle's current speed and headway distance to the nearest forward object. Rapidly increasing ACI indicates a deteriorating perceptual situation and results in proportionally compressed stage transition times. High vehicle speed with short headway similarly compresses stage durations to ensure driver re-engagement before the vehicle approaches a potentially misperceived critical object.

Stage 1 137 of the re-engagement sequence activates when the authority floor falls below T_reengage. In Stage 1, the system illuminates a soft visual indicator in the instrument cluster and generates a single brief auditory chime. The visual indicator communicates that the ADAS system has detected elevated inter-sensor conflict but remains operational at reduced authority. Stage 1 does not interrupt the driver's current activity but informs the driver that monitoring attention is requested. Stage 1 persists for up to T_1 seconds, where T_1 is nominally 8.0 seconds but is compressed to T_1·(1−k_rate·(dADI/dt)/ADI_max) under rapid ACI escalation, with k_rate=0.6 and T_1 subject to a minimum of 2.0 seconds. If the ACI falls below T_reengage during Stage 1 (indicating natural recovery agreement), the stage is cancelled and the authority floor is restored subject to the hysteresis recovery window.

Stage 2 138 activates if Stage 1 times out without ACI recovery, or immediately upon a transition from ELEVATED to CRITICAL ACI tier regardless of Stage 1 timer status. Stage 2 generates a prominent visual alert on a head-up display (HUD), a continuous auditory tone at a frequency selected to convey urgency without alarm, and a haptic pulse sequence delivered via the steering wheel grip surface at a rate of two pulses per second. Stage 2 requests that the driver place hands on the steering wheel and direct active visual attention to the road ahead.

The autonomous driving mode is maintained during Stage 2 but at the minimum authority floor AF_minimum (SAE Level 1), with the HMI displaying a countdown timer showing the remaining Stage 2 window. Stage 2 persists for up to T_2 seconds, nominally 10.0 seconds, subject to the same compression formula as Stage 1.

Stage 3 activates if Stage 2 times out without driver re-engagement confirmed by steering wheel contact detection and forward gaze detection. Stage 3 generates a high-urgency visual alert displaying the message ‘TAKE OVER NOW’ on the HMI, a high-urgency auditory alert at maximum permitted in-cabin sound level, and an escalating haptic pulse sequence at four pulses per second. The vehicle simultaneously initiates a controlled deceleration at nominally negative 2.0 meters per second squared and activates the lane-centering holding mode to maintain lane position during the transition interval.

Stage 3 displays a countdown timer T_3, nominally 6.0 seconds, after which Stage 4 activates. Stage 3 may be terminated by confirmed driver takeover at any point, in which case the vehicle transitions to manual mode and the re-engagement sequence is cancelled.

Stage 4, the Minimal Risk Condition (MRC), activates if Stage 3 times out without confirmed driver takeover. In Stage 4, the vehicle executes a controlled deceleration to a complete stop within the current travel lane at a deceleration rate calibrated to the current vehicle speed, traffic density, and road geometry. On multi-lane roads at highway speeds, the MRC procedure includes a controlled lane change to the right-most available lane prior to deceleration, executed at a lateral acceleration rate not exceeding 1.0 meter per second squared. Upon reaching a full stop or a safe reduced speed, the vehicle activates hazard warning lights and transmits a structured incident notification to the OEM telematics platform comprising the vehicle identifier, GPS location, timestamp, the ACI trajectory leading to MRC activation, and the driver re-engagement stage reached prior to MRC activation. The MRC procedure is designed to comply with the Minimal Risk Condition requirements of UN Regulation 157 (ALKS) and applicable guidance from the National Highway Traffic Safety Administration (NHTSA) for SAE Level 3 automated lane-keeping systems.

Driver response outcomes range from the response to MRC, vehicle stopped safely 144 to Driver assumes control 143, to Hands on wheel detected 142, to ACI Nominal 141, wherein full authority is restored.

In a first preferred embodiment suitable for mass-market vehicles equipped with a forward-facing camera and a forward-facing short/long range RADAR unit—representing the hardware configuration of current SAE Level 2 ADAS platforms—the variance monitor computes Conflict Scores for all forward objects detected in the vehicle's collision zone. CS_presence and CS_range are computed as described above over the camera and RADAR state estimates. CS_velocity is computed using optical flow-derived camera velocity where available, or uses the RADAR-only velocity estimate with a partial conflict penalty if camera velocity is unavailable. CS_class uses the camera's semantic classification output against the RADAR's object class output where RADAR classification is available. The ACI computation covers the forward hemisphere to a configurable detection range.

This embodiment requires no hardware beyond what is present in current-generation SAE Level 2 ADAS platforms and is deployable as a software addition to existing ADAS compute architectures with spare processing capacity, nominally requiring less than five percent of available compute budget for the conflict monitoring computation at 30 Hz operation.

In a second preferred embodiment suitable for SAE Level 3 and higher autonomous driving platforms equipped with camera, RADAR, and LiDAR sensor suites, the variance monitor computes Conflict Scores for all detected objects in full three hundred sixty degree coverage. LiDAR-RADAR range conflict is particularly diagnostically valuable in adverse weather conditions, where LiDAR returns degrade due to precipitation attenuation while RADAR range performance is substantially weather-independent; a camera-LiDAR presence conflict in clear weather is particularly diagnostic of the phantom detection failure mode. The three-sensor conflict profile enables finer-grained ACI computation and higher sensitivity to anomalous perceptual states relative to the two-sensor baseline embodiment.

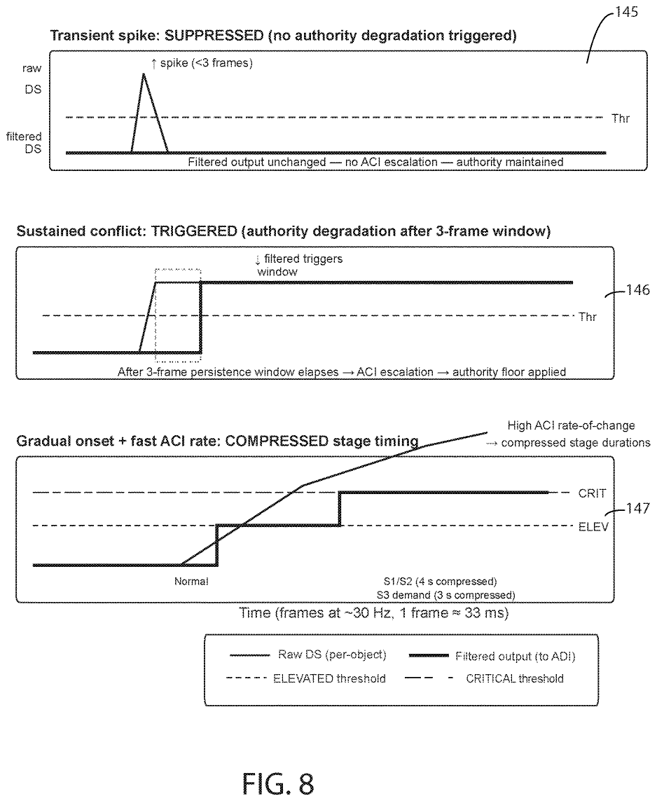

FIG. 8 is a timing diagram illustrating the temporal persistence filter behavior across three scenarios. A first scenario 145 illustrates a transient spike that does not trigger an authority degradation. A second scenario 146 illustrates a sustained conflict that triggers authority degradation after a 3-frame window wherein the authority floor is applied. In a third scenario 147 illustrates a rapid rate of change in the aggregate conflict index (ACI) wherein the driver re-engagement sequence is engaged.

The variance monitor applies a temporal persistence filter that measures the duration that an object is detected and the level of the conflict score (CS) before passing the CS to the conflict classifier. The temporal persistence filter distinguishes a sustained conflict from a momentary conflict. A sustained conflict is indicative of a genuine obstacle, while a transient single-frame conflict is commonly attributable to a measurement timing error or momentary sensor occlusion or the natural latency difference between sensor refresh rates.

The temporal persistence filter maintains a rolling window buffer for each object over a set of N-persist frames that is nominally three frames but may be configurable in the range of two to ten frames. The temporal persistence filter passes the CS to the conflict classifier only when the object has been detected for more than three frames and when the CS has exceeded the ELEVATED classification threshold as shown in diagram 146. A CS that exceeds the threshold in a single frame but returns below a threshold within the 3-frame window is suppressed by the temporal persistence filter as illustrated in the diagram 145. The temporal persistence filter's output CS_Filtered is set to the maximum CS observed over the 3-frame window when the persistence condition is met and is set to zero when the persistence condition is not met. The persistence window duration of three frames at 30 frames per second corresponds to approximately 100 milliseconds. This duration is sufficient to distinguish sensor noise from genuine perception anomalies, which typically persist over multiple frames as the vehicle and the anomalous scene feature maintain their relative positions.

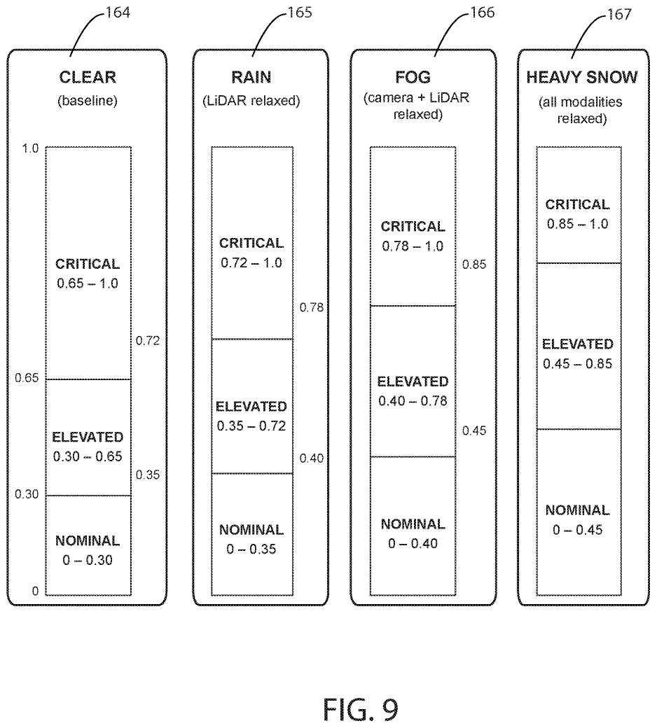

FIG. 9 is a diagram illustrating weather-adaptive conflict threshold modulation. The Conflict Score Thresholds T_nominal and T_critical are modulated based on the vehicle's current environmental condition classification. The environmental condition classifier receives inputs from the vehicle's windshield rain sensor, ambient light sensor, and camera-based visibility estimator to classify the current condition as one of: CLEAR 164, RAIN 165, FOG 166, or HEAVY_SNOW 167. One skilled in the art understands that further gradations may include LIGHT_RAIN, HEAVY_RAIN, LIGHT_SNOW and the like.

Under HEAVY_RAIN conditions, T_nominal is increased from 0.30 to 0.35 and T_critical is increased from 0.65 to 0.72 for the LiDAR-camera presence conflict dimension specifically, reflecting the expected higher conflict score due to LiDAR return attenuation in rain. Under FOG conditions, both T_nominal and T_critical are relaxed for the camera-dependent CS_presence dimension. Under HEAVY_SNOW, all thresholds are relaxed uniformly to their maximum values across all dimensions. The threshold relaxation is computed using a lookup table based on condition and dimension factors that are updateable via over-the-air (OTA) firmware update.

The weather-adaptive modulation ensures that the conflict monitoring system maintains consistent signal-to-noise characteristics across environmental conditions, capturing genuine perception anomalies while suppressing nuisance triggers attributable to expected physics-based inter-modality variation.

1. An autonomous vehicle control system for managing operational authority based on sensor data reliability, comprising:
a primary sensor fusion pipeline configured to receive raw data from a plurality of sensor types and generate a fused world-model; and
a parallel conflict monitoring layer comprising a data tap configured to read independent object lists generated by each individual sensor from the primary sensor fusion pipeline prior to data fusion; and
a variance monitor configured to calculate a conflict score for a tracked object based on a discrepancy between at least two of the plurality of sensor types; and
a conflict classifier configured to calculate an aggregate conflict Index representing a distribution of conflict across all tracked objects; and
an authority module configured to generate an autonomous authority floor as a function of the aggregate conflict index, wherein the authority floor dynamically suppresses or downgrades recommended vehicular actions that exceed a permitted automation level defined by the authority floor.

2. The system of claim 1 wherein:
the plurality of sensor types includes at least two of: a camera, a RADAR unit, and a LIDAR unit.

3. The system of claim 1 wherein:
the conflict score is computed as a weighted linear combination of four dimensions comprising: presence probability conflict, range conflict, relative velocity conflict, and semantic classification conflict.

4. The system of claim 1 wherein:
the weighted linear combination is defined by the formula:
$$CS = {w}_{presence} * {CS}_{presence} + {w}_{range} * {CS}_{range} + {w}_{velocity} * {CS}_{velocity} * {w}_{class} + {CS}_{class}$$
and wherein the weight vector is dynamically adjustable based on the vehicle's current operational design domain.

5. The system of claim 1 wherein:
the variance monitor further comprises a temporal persistence filter configured to maintain a rolling window buffer of conflict scores over a set of N_frames; and
pass the conflict score to the conflict classifier only when the tracked object is detected for more than a threshold number of frames and the conflict score exceeds a defined severity threshold.

6. The system of claim 1 wherein:
the authority module applies a hysteresis band to the autonomous authority floor such that the authority floor is reduced immediately upon the aggregate conflict index crossing an upward threshold, but is only restored after the aggregate conflict index remains below a downward threshold for a minimum recovery window duration.

7. The system of claim 1 further comprising:
a driver re-engagement sequencer configured to activate a graduated four-stage escalation protocol when the autonomous authority floor falls below a re-engagement threshold, the protocol comprising:
Stage 1: a visual indicator and an auditory chime; and
Stage 2: a haptic pulse sequence delivered via a steering wheel and a head-up display alert; and
Stage 3: a high-urgency auditory alert and initiated controlled deceleration; and
Stage 4: execution of a minimal risk condition comprising a controlled stop of the vehicle.

8. The system of claim 7 wherein:
the duration of the stages in the escalation protocol is compressed proportionally based on a rate of change of the aggregate conflict index (ACI) as: ACI (dACI/dt) or the vehicle's current speed and headway distance.

9. The system of claim 7 wherein:
the minimal risk condition of Stage 4 includes a controlled lane change to a right-most available lane and the transmission of an incident notification to a telematics platform including the aggregate conflict index trajectory leading to activation.

10. The system of claim 1 further comprising:
an environmental condition classifier configured to modulate the conflict classifier's severity thresholds, from a nominal threshold to a critical threshold, based on detected weather conditions including rain, fog, or snow, to account for physics-based inter-sensor variation.
